(19) United States
(12) Patent Application Publication
(10) Pub. No.: US 2004/0047347 A1
(43) Pub. Date: Mar. 11, 2004

(54) Method, system and apparatus for reprogramming a digital electronic device via a computer network

(76) Inventors: Michael Worry, San Jose, CA (US); Alan Lattanner, Fremont, CA (US); Stephen Kingsley-Jones, San Jose, CA (US)

Correspondence Address: GRAY CARY WARE & FREIDENRICH LLP, 2000 UNIVERSITY AVENUE, E. PALO ALTO, CA, 94303-2248, US

(21) Appl. No.: 10/054,364

(22) Filed: Nov. 13, 2001

Related U.S. Application Data
(60) Provisional application No. 60/247,816, filed on Nov. 13, 2000.

(51) Int. Cl. H04L 12/28

(52) U.S. Cl. 370/389

(57) ABSTRACT

A method and apparatus for reprogramming a digital electronic device or Appliance is provided. A preferred embodiment locates a reprogrammable Controller chip in the communications flow between a reprogrammable digital device and an application server. The application server transmits commands and programming data to the Controller chip in data packets via the Internet. The Controller sniffs each data packet to determine the type of data contained therein. The Controller will immediately forward certain types of data packet onto the digital device. Alternatively, the Controller may store data packets that relate to the reprogramming of either the digital device or the Controller itself, for collation and later transference during a reprogramming of the digital device or the Controller. Data packets may contain upgrade data, status queries, monitoring instructions, logic settings, and other information relating to the operation and status of the server, device or Controller. The application server of the preferred embodiment transmits Controller and device specific instruction commands via the Internet that are related to the native language of the Controller and/or the digital device. The device may be programmed to periodically check in with the applications server for purposes such as security, reporting, maintenance and/or refreshing the operational methodology of the system. The periodic check-ins maybe real time based, time-period based and/or event driven. The Controller may optionally be accelerated by a high performance processor. The Controller may use PKI encryption techniques, store public keys and private keys, and generate public/private key pairs.

### FIELD OF THE INVENTION

The present invention relates to methods and systems useful for communicating operational parameters, instructions, monitoring information, status reports and other data between a central location and a remotely located electronic circuit. More particularly, the present invention relates to the advantages of reprogramming electronic devices via a computer network.

### BACKGROUND OF THE INVENTION

The use of reprogrammable electronic devices is widespread in the arts of medical, industrial, consumer and military systems design. The advantages of altering or upgrading the performance of a particular reprogrammable device, or of a large system, by means of reprogramming one or more reprogrammable digital electronic devices have been employed in the prior art to increase the utility of numerous systems and Appliances. The performance of many of the methods, Appliances, systems and apparatuses that incorporate reprogrammable digital electronic devices are dependent upon the accessibility of a reprogrammable device for new programming.

The terms reprogrammable digital electronic device, Target Device and Target are used herein as identical and to include any digital electronic device that is altered in state or in performance by the acceptance of information that reconfigures or resets a logic gate, memory cell, a register, a value representing circuit, a plurality of interconnections between or among logic gates or cells, or other suitable electronic structures known in the art that reprogrammably store information.

The term Appliance is used herein to include any system that reacts to, communicates with or interacts with a Target Device. The terms Data Packet and Messages are used herein to denote an electrical signal or electronic message that contains information.

The art of designing Appliances that benefit in performance or vary in utility upon the basis of a reprogramming of one or more reprogrammable digital electronic devices or Targets will significantly increase the value that the art delivers to industry and the public by advances made in the methods, systems and apparatuses used to execute Target reprogramming.

### OBJECTS OF THE INVENTION

It is an object of the present invention to provide a system that enables the reprogramming of a reprogrammable digital electronic device via a computer network, such as the Internet, an intranet, an extranet or another suitable computer network known in the art.

It is a further object of the present invention to increase the range of effective applications of reprogrammable digital electronic devices.

### SUMMARY OF THE INVENTION

These and other objects and advantages of the present invention are achieved by the method of the present invention wherein a method, system and apparatus is provided for the use, support and management via a computer network of Appliances that are linked with reprogrammable electronic circuits. The invented system may include a reprogrammable digital electronic circuit in communication with an Appliance, or placed as a component of the Appliance, a Controller in communication with the reprogrammable digital electronic circuit, an Application Server, and a Computer Network that provides a data path for bi-directionally transmitting information between the Controller and the Application Server, and/or to a Target and the Computer Network via the Controller.

Each Controller is assigned a unique identification code, or Controller ID, that distinguishes a particular Controller from all other Controllers. The unique Controller ID, or ID, identifies the individual physical hardware to which it is assigned. This assignment of the ID enables the tracking and communications access to the Controller at times and phases after the assignment. A particular Controller might thereby, in certain preferred embodiments of the present invention, be tracked and communicated with at various points of manufacture and use, such as after the fabrication of an incomplete or partially functioning Controller on a substrate, or during final assembly and test of Controller, or upon connection with a Target, or during test and assembly of the Appliance, or during field service analysis, diagnosis or preventive maintenance, or during operation of the Appliance. The entire or nearly the entire life cycle of a particular Controller may thereby be monitored by means of addressing communications to the ID of the Controller.

In the preferred embodiment the reprogrammable digital electronic circuit, or Target, may be reprogrammed by the receipt of Data Packets transmitted from the Applications Server and via the Internet and the Controller. The Target bi-directionally communicates to the Application Server via the Controller and the Internet. The Controller includes a Protocol Core, an Upgrade Engine, a Network Interface, a Memory Block, a Memory Block Interface, and a Target 1/0 Interface Circuit. The Controller may optionally reside inside a Microprocessor, whereby the speed of performance of the Controller is enhanced during at least certain operations. The Network Interface includes a Sniffer Circuit and an Output Transceiver Circuit. The Sniffer Circuit, or Sniffer, substantively provides a data path for information passing from the Internet to the Controller. The Output Transceiver provides a data path for information passing from the Controller to the Internet. The Sniffer accepts and examines data packets transmitted via the Internet to the Controller. The Sniffer determines the type of a Data Packet and at least partially directs the flow of the packet within the Controller, to the Memory Block and/or the Target in accordance with an operational program of the Controller. The operational program of the Controller may be stored wholly or partially in an optional Controller Memory. The Controller Memory may optionally be reprogrammable by means of loading of operational information and instructions delivered from the application server by the Internet and via the memory block. The Memory Block is used for processing and storing information that is subsequently transmitted to the Target or optionally to the Controller memory. The Memory Block of the preferred embodiment is non-volatile. In certain preferred alternate embodiments of the present invention the Memory Block is a dynamic electrical or electronic circuit.

In certain alternate preferred embodiments of the method of the present invention the Memory Block may comprise at least one or a plurality of information accepting and storing circuits that are physically distributed about the Controller, the Appliance and/or the Target.

In the preferred embodiment, an optional Real Time Clock built into the Target and/or Appliance is useful for scheduling real time based or time durational-based operations of the Controller, Target and/or the Appliance. The Target 1/0 Interface delivers data directed from the Sniffer circuit or the Memory Block to the Target and receives data from Target. Data received from the Target may be processed by the Controller and/or transmitted via the Network Interface and the Internet to the application server or another Controller, Target or Appliance. Peer to peer communication is thus optionally enabled by the preferred embodiment.

In the preferred embodiment the Controller stores a unique controller identifier, or ID, and one or more sets of private/public keys. The private/public keys are encryption and decryption keys used to encrypt messages prior to transmission from the Controller and to decrypt messages received by the Controller.

The Memory Block of the preferred embodiment includes an A sector for storage of a first set of Target data, a B sector for storage of a second set of Target data. The preferred embodiment of the present invention further provides a Controller Memory Block with a C sector for a first set of Controller program data and a D sector for storage of a second set of Controller program data. Both the first and second set of Target data are intended to be alternatively loaded into the Target via the Target I/O interface, whereby the Target data thereby transmitted to the Target affects the operation of the Target and/or the Appliance. Both the first and second Controller program data may be intended to be alternatively delivered to the Controller Memory, whereby the operational program of the Controller comprises the information contained within the loaded Controller program data. Certain alternate preferred embodiments of the method of the present invention employ a Unified Memory Block that provides the combined functionality of the Memory Block and the Controller Memory Block. The Unified Memory Block, the Controller Memory Block and the Memory block may be volatile or non-volatile electronic memory in certain still alternate preferred embodiments of the method of the present invention.

Certain preferred embodiments of the method of the present invention enable a scheduling of a reprogramming of the Target and/or Appliance to a set time or in response to a predetermined event, or to the passing of a preset time period after a predetermined event.

The method of the present invention actualized in the preferred embodiment accepts Data Packets from the Internet via or via the Network Interface. Data Packets that contain certain preset designations are transmitted to the memory block for later transmission to either the memory of the Controller or the Target. Data Packets selected and indicated for processing by the Controller prior to transmission to the Target may include information of various natures, to include software or firmware upgrades for the Controller, the Target or the Appliance, Encryption and/or Session Keys, remote control monitoring instructions or information, commands, diagnostic software, digital signatures, license identifications, operational histories, status report, status queries, information or measurements relevant to royalty tabulations, firmware enhancements, digital watermarks, monetary or pseudo-monetary tokens or account information, operational limitations or permissions, terms or conditions of licenses, and other suitable types of information, data or instructions known in the art.

Alternatively, certain differing preferred embodiments of the present invention do not store programming information for the Target and/or the Appliance and may refresh the Target with information without storage in the memory block. This direct transferal of data from the Sniffer, through the Controller and to the Target may insure that the Target is directly and quickly refreshed from the application server upon a reset command.

In the preferred embodiment the Target may power up in response to a reset command transmitted by the Controller. The power up of the Target may be performed with a new set of programming information, or Target data, that is substantively stored and transmitted from the Memory Block to the Target. The Target may then perform a power on self-test. If and when a Target's power on self test fails, the Controller may provide the Target with an alternate set of Target data, such as a previous or the most recent set of Target programming information, and the Target will then receive this alternate set of information and again perform a power on self-test. The Controller or Target may then issue a power on self-test report to the computer network that informs a peer or the application server of the results of one or more power on self-tests. A failure of any power on self test may be detected or indicated by the lack of receipt of an expected Message from the Target to the Controller within a prespecified time period after the power on had commenced.

In certain preferred embodiments of the method of the present invention the Target or Controller is directed to make a periodic or event driven or asynchronous communications contact with a peer or the application server. This contact may inform the peer or the application server of the identity and/or network address of the Controller, the Target and/or the Appliance. Failure to make this contact may result in the preprogrammed disablement of the Controller, Target or Appliance. The communications contact may also inform the peer or the server about the history and/or status of the Controller, Target and/or Appliance. The communications contact may thus be used in certain preferred embodiments of the present invention to locate the Controller, Target and/or Appliance and create a necessity for occasional, periodic or scheduled communications linkage between the Controller, Target or Appliance and a peer, the server, or another element that is available to the computer network. The communications contact process of certain preferred embodiments of the method of the present invention may be optionally used to increase the level of security of an environment with which an Appliance or a plurality of Appliances operates. An optional real time clock may be used to schedule or coordinate the communications contact by providing a real time notice to the Controller or Target.

In the preferred embodiment the Controller may store and generate public and private key pairs and transmit the public keys via the Internet to a peer or the application server. The Controller uses the private and public key pairs to encrypt and decrypt messages and data packets transmitted to and from the Controller. Specific communications or messaging transactions may be individually identified, serialized, tagged or labeled and may identify or indicate the Controller, server, Target, Appliance, peer or other element or elements. This process of uniquely identifying specific message transactions may be useful in the administration, management, failure diagnosis and analysis of the Controller, Target, Appliance, server, peer or other elements available to the computer network.

In certain alternate preferred embodiments of the method of the present invention a system may transmit a Data packet or Message that comprises commands, data or information via the computer network and to or from the Controller, Target, Appliance, server, one or more peers in software code that is related to the native language of an originator, a transmitter or a receiver of a message or data packet. In the preferred embodiment the instruction set of the Controller is used in messages transmitted between the Application Server and the Controller. This use of commands stated in the native language of the Controller by the preferred embodiment may result in a more optimal execution of commands by the server, the Controller, the Target or the Appliance, and may allow for a simpler and less power consumptive design of the Controller.

Information transmission, message and message sender validation, authorization, credentialization and authentication may be performed in a numerous variety of alternate preferred embodiments of the method of the present invention that incorporate suitable encryption, decryption, authentication, validation and credentialization techniques and methodologies known in the art.

Certain preferred embodiments of the method of the present invention comprise the use of XML language software and/or XML messaging, or other suitable software techniques, software systems and software languages known in the art. BREF DESCRIPTION OF THE DRAWINGS

These, and further features of the invention, may be better understood with reference to the accompanying specification and drawings depicting the preferred embodiment, in which:

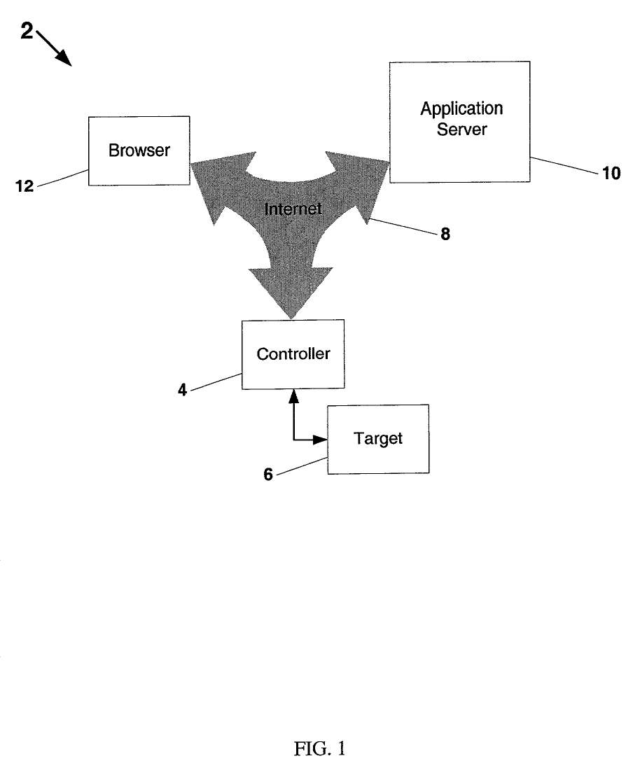

FIG. 1 depicts a preferred embodiment of the present invention.

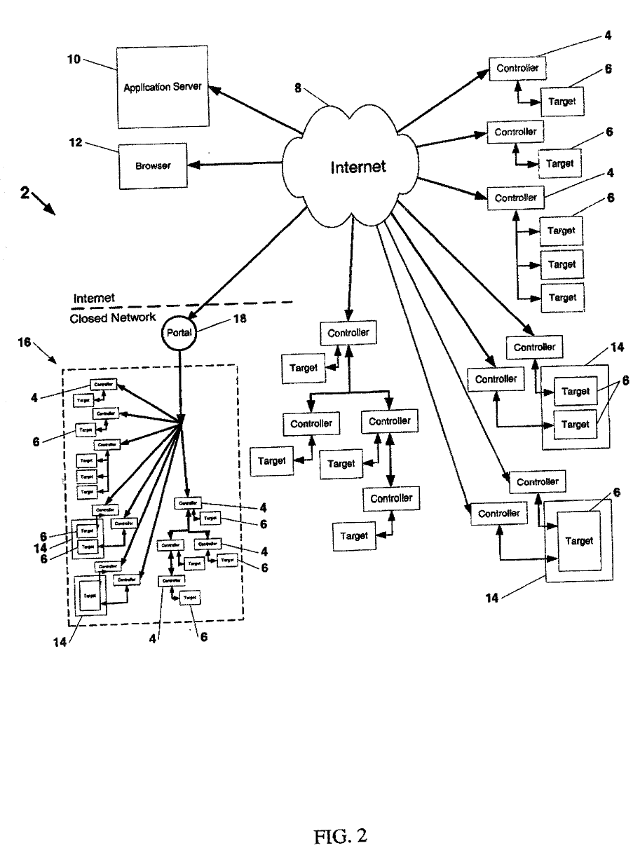

FIG. 2 is an illustration of the preferred embodiment of the present invention of FIG. 1 wherein a plurality of Controllers is in communication via the computer network.

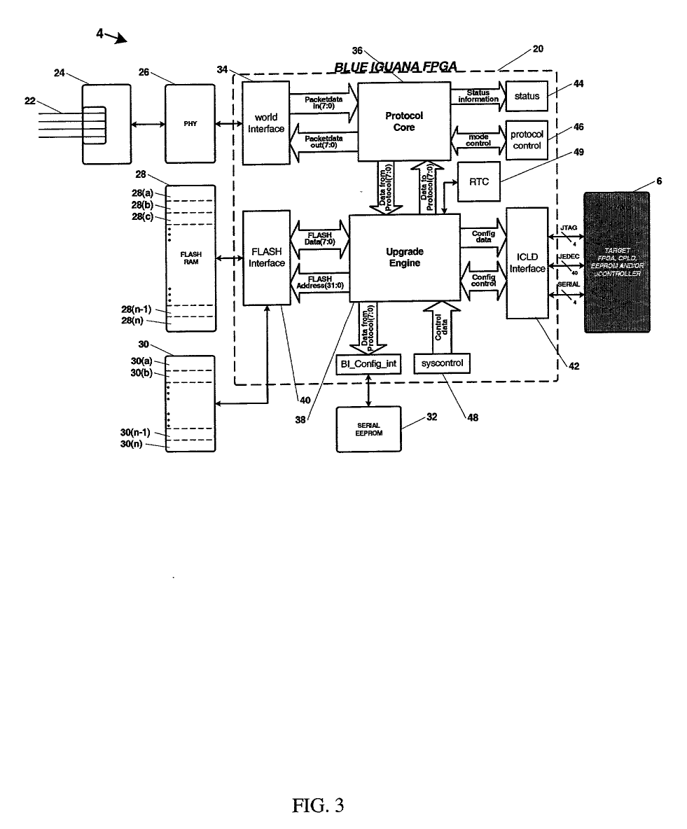

FIG. 3 is a schematic diagram of the Controller and the Target of FIG. 1.

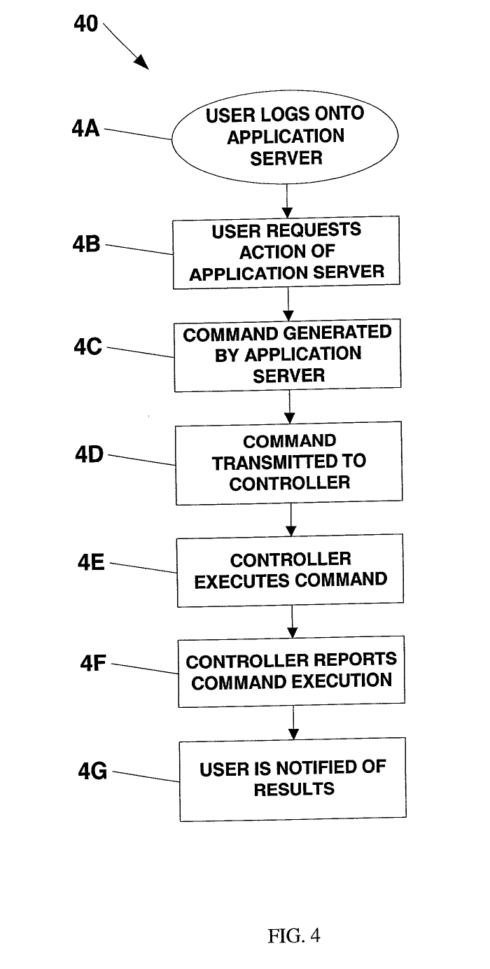

FIG. 4 is a first work process flow chart of a user interacting with the Server and the Controller of FIG. 3.

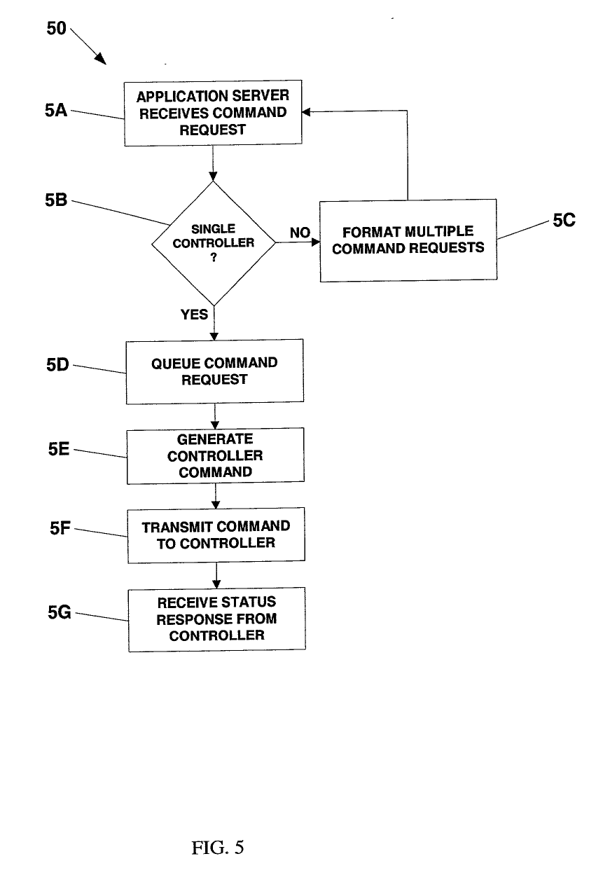

FIG. 5 is a second work process flow chart of the interaction of the Controller and the Server of FIG. 1.

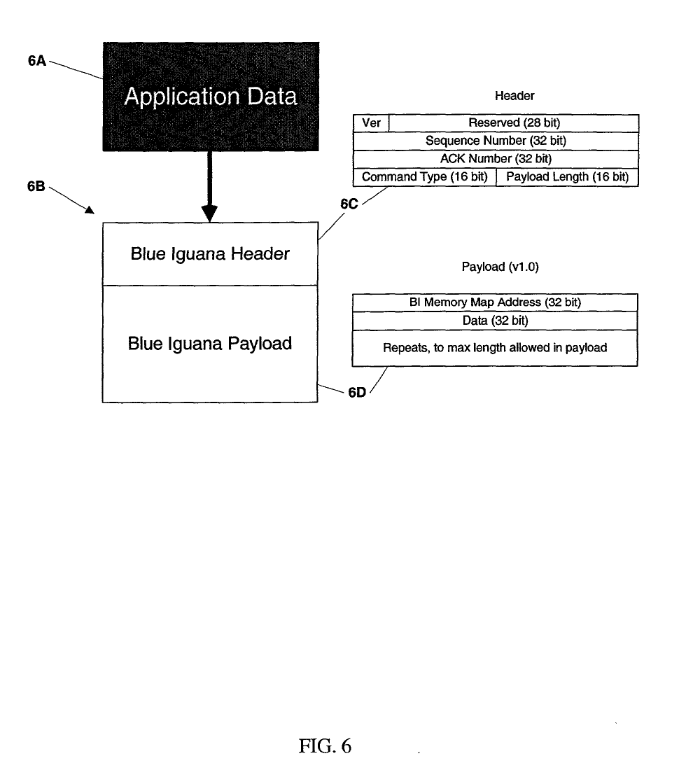

FIG. 6 is a schematic diagram of a Header and Payload contained in a Message sent from the Application Server of FIG. 3 and the Controller of FIG. 3.

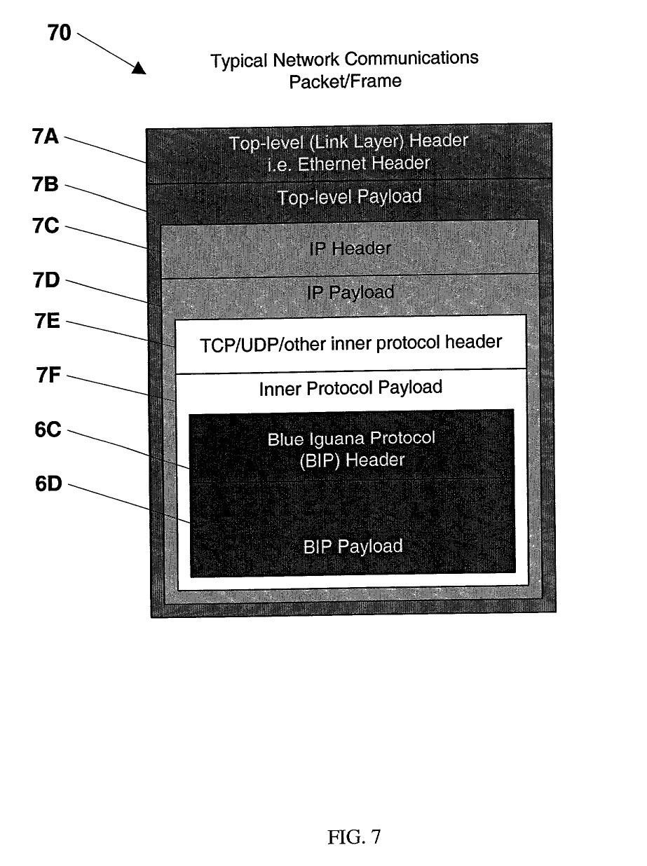

FIG. 7 is a schematic diagram of a Data Packet sent from the Application Server of FIG. 3 and the Controller of FIG. 3.

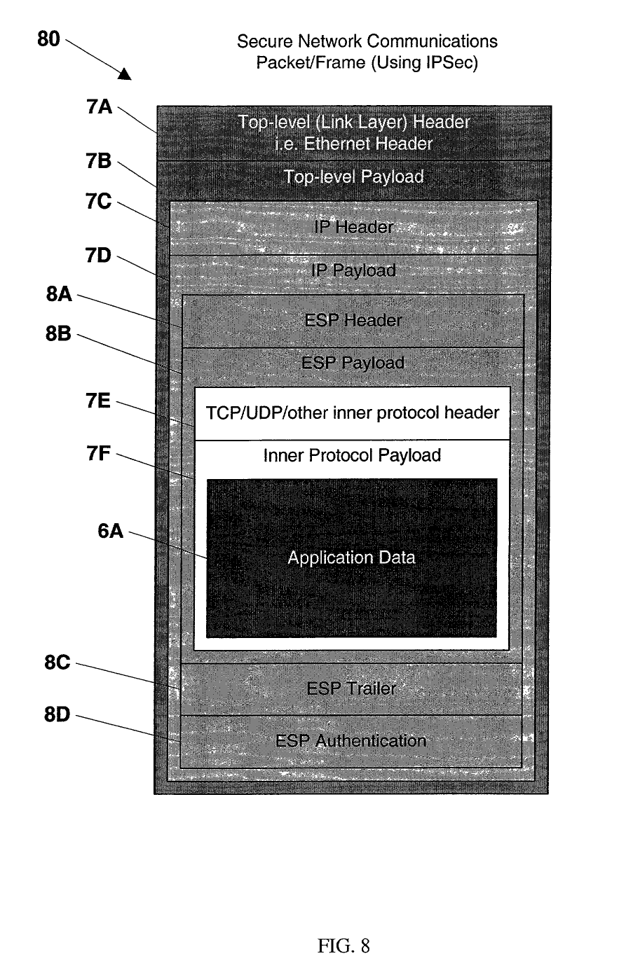

FIG. 8 is a schematic diagram of a Data Packet sent from the Application Server of FIG. 3 and the Controller of FIG. 3, wherein the Data Packet further includes encryption information.

### DETAILED DESCRIPTIONS OF THE PREFERRED EMBODIMENT

In describing the preferred embodiments, certain terminology will be utilized for the sake of clarity. Such terminology is intended to encompass the recited embodiment, as well as all technical equivalents which operate in a similar manner for a similar purpose to achieve a similar result.

Referring now generally to the Figures and particularly to FIG. 1, a preferred embodiment of the method of the present invention 2 includes a Controller 4, a Target 6, an Internet 8, an Application Server 10, and a Browser 12. The Application Server, or Server 10, and the Controller 4 communicate bi-directionally via the Internet 8. The communication modality between the Server 10 and the Controller 4 may comprise a wireless Internet communications system, a wireless and/or a land based telephone line. The application server communicates with the Target 6 by building a Data Packet 70, 80, of FIGS. 7 and 8, according to predesignated formats and transmitting the Data Packet 70, 80 or a plurality of Data Packets 70, 80, via the Internet 8 to the Controller 4. The Controller 4 examines each Data Packet 70, 80 received via the Internet 8 and determines how to process and/or transmit each Data Packet 70, 80 within the Controller 4, Target 6 and/or Appliance 14 upon the basis of the format of the Data Packets 70, 80 and the information contained within the Data Packets 70, 80. Certain Data Packets 70, 80 will be most promptly forwarded on to the Target 6, whereas certain other Data Packets 70, 80 of varying formats and content will be slightly or extensively processed by the Controller 4 and may or may not be transmitted to the Target 6 during or after a single or a plurality of processing steps.

Referring now generally to the Figures and particularly to FIGS. 1 and 2, a System 2 of a one or a plurality of Controllers 4 are coupled to one or more Targets 6 and to the Internet 8. The System 2 of FIGS. 1 and 2 enable bi-directional communication between the application server and the plurality of Controllers 4. Communication among the Controllers 4 on a peer to peer basis, where each Controller 4 may be identified as a peer, is additionally enabled by the Internet 8. The use of a single Controller 4 in transmitting information from the Internet to a plurality of Targets 6 and Appliance 14 is illustrated in FIG. 2, as is the communication of a plurality of Targets 6 with a single Appliance 14, and the communication of a plurality of Controllers 4 with a plurality of Targets 6 within a single Appliance. Data Packets 70, 80 of FIGS. 7 and 8 may also be transmitted via the Internet 8 to one Controller 4 and then onto another Controller 4.

A Server 10 generates and transmits information and commands, and receives information and commands, from the Controllers 4. A user may employ a Browser 12 to request the Server 10 to generate and transmit a command or information to one or more Controllers 4. Each Target 6 is in communication with at least an Appliance 14. Appliances 14 may thereby may be identified as a peer and participate via one or more Controllers 4 in peer to peer communication.

The Internet communications of the preferred embodiment include the association of a unique identifier for each Controller 4. Each Controller 4 may also be associated with a network address and/or a universal resource locator, as may each Target 6 and Appliance 14. The assignment of a unique identifier to each Controller 4 is beneficial in the maintenance of secure, validating and authenticating communication protocols and techniques used by the applications server and the Controllers 4. A Closed Network 16 is a computer network that is accessible solely via a Portal 18.

Referring now to the Figures generally and particularly to FIG. 3, the Controller 4 includes a Controller Processor 20. The Controller Processor 20 is linked to the Internet 8 via a plurality of Communications Lines 22, a Transceiver 24, and a Physical Interface 26. An optional Memory Block 28, an optional Controller Memory Block 30, and a serial EEPROM 32 are each coupled to the Controller Processor 20. The Controller Processor 20 of the preferred embodiment may be an applications specific integrated circuit that is designed specifically to be provide processing functions to the Controller 4, or the Controller Processor 20 may be or may include a reprogrammable or a field reprogrammable gate array or another suitable reprogrammable gate array or electronic device known in the art. Certain alternate preferred embodiments of the present invention the Controller Processor 20 may comprise suitable lower cost reprogrammable devices known in the art.

The Serial EEPROM 32 maintains a record of certain configuration information and settings useful to the Controller Processor, such as the unique Controller ID of the Controller 4, InternetPprotocol addresses of the Controller 4, the address and ID of the Application Server, public encryption keys of the Server 10 and other Controllers 4, public and private encryption key pairs of the Controller 4 of the preferred embodiment, timing and scheduling information, and other suitable information useful to the Controller 4 and Controller Processor 20. The Serial EEPROM 32 transmits or makes available the information stored therein to the Controller Processor 20 upon request by the Controller Processor and during a reset, a reprogramming, a reconfiguration, and/or a power up of the Controller Processor 20

A Network Interface 34 of the Controller Processor 20 bi-directionally communicates with the Internet 8 via the Physical Interface 26, the Transceiver 24 and the plurality of Communications Lines 22. The Network Interface 34 includes a Sniffer 34a and an Interface Transceiver 34b. The Sniffer 34a accepts Data Packets 70, 80 and Messages from Internet and through the Physical Interface 26, whereas the Interface Transceiver 34b provides a data path for data transmission from the Controller Processor 20 to the Physical Interface 26 and to the Internet. The Sniffer 34a examines a Blue Iguana Data Packet Header 6C, as shown in FIGS. 6, 7 and 8, of each Data Packet 70, 80, as shown in FIGS. 7 and 8, received from the Physical Interface 26. The Blue Iguana Header 6C of each Data Packet 70, 80 is unencrypted in the preferred embodiment of the method of the present invention. The Sniffer 34a determines from the information contained in the Data Packet Header 6C how to direct the processing of the Data Packet 70, 80 within the Controller 4. The Data Packet 70, 80 is transmitted from the Network Interface to a Protocol Core of the Controller Processor.20. The Protocol Core 20 is designed or configured to decrypt and extract a Blue Iguana Payload 6D from the Data Packet 70, 80 and to transfer the Blue Iguana Payload to an Upgrade Engine 38. Depending upon the information contained in the Blue Iguana Header 6C, the Blue Iguana Payload 6D may be transferred from the Upgrade Engine 38 to a Memory Block Interface 40 and from the Memory Block Interface 40 into Memory Block 28. Alternatively, the Upgrade Engine may transmit be instructed by the information contained in the Blue Iguana Header 6C to a Target I/O Interface 42 and from the Target I/O Interface to the Target 6.

A Status Register 44 of the Controller Processor 20 receives and stores status information from the Protocol Core 36. This status information is useful in determining the condition of the Controller at a specific instant and in root cause failure analysis. A Protocol Control 46 of the Controller Processor 20 affects the functioning of the Controller 4 by designating one or more operational modality set references to the Protocol Core 36, by which the Protocol Core 36 may be commanded to conform to at least one set of pre-established operational parameters and directives. A Syscontrol 48 provides control data to the Upgrade Engine 38.

The optional Controller Memory 30 may contain reprogramming information for the Controller 4 and/or the Controller Processor 20. The Controller Memory 30 of the preferred embodiment is non-volatile digital electronic memory, such as an EEPROM or another suitable electronic memory known in the art. The Controller Memory 30 is partitioned into a plurality of Controller Memory Sectors 30a, 30b, 30n wherein a distinct set of reprogramming and/or reconfiguring instructions for use if reprogramming or reconfiguring the Controller 4 or the Controller Processor 20 are stored. In certain preferred embodiments of the method of the present invention the Controller 4 may be reconfigured and/or reprogrammed by the use of one or more sets of instructions stored in one or more Controller Memory Sectors 30a, 30b & 30c, such that in a unified reprogramming and/or reconfiguring action the Controller 4 may be reprogrammed and/or reconfigured to follow the directives, control statements and/or operational parameters that are presented to the Controller 4 by the information contained within one or more Controller Memory Sectors 30a, 30b and 30n.

In operation, the Target may be reprogrammed or reconfigured by the transmission of data contained in one or more Data Packets 70, 80. This information may proceed, in certain alternate preferred embodiments of the present invention through the Controller Processor 20 without being stored in the Memory Block 28. Preferred embodiments of this type may require the reprogramming or reconfiguring of the Target via the retransmission of data from the Server 10, or another data generator, via the Internet 8 or the Closed Network 16.

Alternatively, the Target 6 may be reprogrammed and/or reconfigured with information that is delivered to the Controller 4 and stored and/or assembled in the Memory Block 28. The Memory Block 28 may contain distinct sequences of information that are separately stored in a plurality of Memory Sectors 28a, 28b, 28n of the Memory Block 28. A reprogramming and/or reconfiguring action of the Target may be accomplished by delivering one or more distinct sequences of information stored in the Memory Sectors 28a, 28b, 28n of the memory Block 28 through the Controller Processor 20 and to the Target 6.

In certain alternate preferred embodiments of the method of the present invention, the Target 6 may first be programmed and/or configured with a first sequence of information stored in a Memory Sector A 28a of the Memory Block 28. The Target 6 may then be subsequently reset and reprogrammed with a second sequence of information stored in a Memory Sector B 28b of the memory Block 28. The Target 6 will then power up and reprogram and/or reconfigure with the second sequence of information and perform a power up self test. The Target will then inform the Controller Processor 20 of the results of the power up self test. Alternatively, or in addition, the Controller may wait for the receipt of a signal from the Target 6 that confirms a successful result from the reprogramming and/or reconfiguring of the Target 6 with the second sequence of information. The failure of the Controller 4 to receive the successful result signal from the Target 6 within a specific time period may be interpreted by the Controller 4 as a failure of the Target 6 to successfully power up. The Controller 4 may then repeat the reset and reprogramming and/or reconfiguring of the Target 6 with the second sequence of information one or more times, or the Controller 4 may attempt to successfully reprogram and/or reconfigure the Target 4 with the retransmission of the first sequence of data to the Target 4. In the preferred embodiment, the Controller 6 reports many or all successful and failed resets, reprogramming and/or reconfigurations of the Target 6 to the Server or another Controller 6 or entity via the Internet 8.

The preferred embodiment includes a Real Time Clock 49. The Real Time Clock 49 is optionally used to execute scheduled resets and reprogramming and/or reconfiguring of the Target 6. In certain alternate preferred embodiments of the present invention the Controller 4 and/or Target 6 are programmed or commanded to be reprogrammed and/or reconfigured by the delivery of a third sequence of information from the Internet 8. This alternate step of the method of the present invention may insure that the Target 6 is in communication, and possibly to locate where and how the Target 6 and/or the Controller 4 are being employed. This optional requirement of a check-in of the Target 6 or the Controller 4 with the Server 10, another Controller 4 or another entity, via the Internet 8, the Closed Network 16 or another suitable communications network may be useful in enforcing licensing agreements or creating barriers to unauthorized uses of Controllers 4, Targets 4 or Appliances 14.

In certain alternate preferred embodiments of the method of the present invention, the Controller Processor 20 may first be programmed and/or configured with a first sequence of controller information stored in a Memory Sector C 30a of the Controller Memory Block 30. The Controller Processor 20 may then be subsequently reset and reprogrammed with a second sequence of controller information stored in a Controller Memory Sector D 30b of the Controller Memory Block 30. The Controller Processor 20 will then power up and reprogram and/or reconfigure with the second sequence of controller information and perform a power up self test. The Controller Processor 20 will then inform the Server 10 of the results of the power up self test. Alternatively, or in addition, the Server 10 may wait for the receipt of a signal from the Controller Processor 20 that confirms a successful result from the reprogramming and/or reconfiguring of the Controller Processor 20 with the second sequence of controller information. A failure of the Server 10 to receive the successful result signal from the Controller 4 within a specific time period may be interpreted by the Server 10 as a failure of the Controller Processor 20 to successfully power up. The Server 10 may then repeat the reset and reprogramming and/or reconfiguring of the Controller Processor 20 with the second sequence of controller information one or more times, or the Server 10 may attempt to successfully reprogram and/or reconfigure the Controller Processor 20 with the retransmission of the first sequence of controller information to the Target 4. In the preferred embodiment, the Controller 4 reports many or all successful and failed resets, reprogramming and/or reconfigurations of the Controller Processor 20, subject to the affect of a failure of the Controller Processor 20 to power up and attain full functionality.

The Controller 4 of the preferred embodiment generates public and private key pairs for use in encrypting and decrypting communications. The Controller 4 stores the public and private keys and distributes the public key via the Internet.

Referring now generally to the Figures, and particularly to FIG. 4, a First Work Flow Diagram 40 of an interaction of a user with a Controller 4 begins with a Step 4A, wherein the user logs onto the Server via the Browser 12 and the Internet 8. The user generates and transmits a request for action by one or more Controllers 4 via the Browser 12 to the Server 10 in Step 4B. In step 4C the Server responds to the user's request and builds a command for the intended Controller 4 or Controllers 4. In Step 4D the Server 10 transmits the command to the intended Controller 4 or Controllers 4. The user-specified Controller(s) 4 receive and execute the command in Step 4E. In Step 4F each selected Controller(s) 4 report to the Server 10 regarding the status of the execution of the command as formatted and transmitted by the Server 10. The Server 10 then reports on the status of the actions requested by the user to the user via the Browser 12.

Referring now generally to the Figures, and particularly to FIG. 5, a Second Work Flow Diagram 50 describes actions and interactions of the Server 10 and a Controller 4 that occur within the Steps 4B and 4F of the First Work Flow Diagram. In Step 5A the Server 10 receives an action request from the user. The action request may include the parameters of a command, such as a primitive and optionally a file. The action request may specify the existence of an association between the requested action and a shade. The action request, or command request, may include a time specification for the performance of the action. The action request may further specify one or more particular Controllers 4, or a group or herd of Controllers 4, where the indicated Controller(s) 4 are requested by the user to execute the requested action.

In Step 5B of the Second Work Flow Diagram 50 the Server determines if more than one Controller is required to fulfill the user's action request. If so, the Server moves to Step 5C and builds individuated command requests for each Controller 4. The individuated command request will each specify only one Controller 4 as identified by a unique Controller ID. Once the command request is formatted to a single Controller ID, the Server places the command request into a queue. This scheduling may be based upon the time specification information provided by the user in Step 5A and other factors of discernable to the Server 10. The command may be scheduled for immediate generation and transmission or delayed for a later generation and transmission. Still alternately, the command may be generated for immediate generation and transmission to the Controller 4 but may specify a delayed execution by the Controller 4, the Target 6 and/or the Appliance 14.

The generation of the command for transmission to the selected Controller 4 occurs in Step 5E. The Server 10 includes in the command the ID of the Controller 4, the command parameters such as the primitive and the file, if any, that was transmitted by the user and associated with the command request and the Controller ID. Scheduling information regarding a timing of the performance of the requested action, as designated by the user and/or the Server 10, is additionally included in the command. The Server may optionally include a public encryption key of the Controller 4 within the command. The Server formats the command according to an appropriate command structure retrieved from a library of command structures. The selected command structure will be relevant to the requested action and the nature of the Controller 4, Target 6 and or Appliance 14.

The Server formats the command into one or more Blue Iguana Data Packets 70, 80. A Master Packet 70,80 is formed and optionally encrypted with the public encryption key of the Controller 4. The Master Packet 70, 80 is sent to the specified Controller 4 and addressed to the unique Controller ID, a Universal Resource Locator, an Internet protocol Address and/or another suitable computer network address associated with the selected Controller 4. When the command can not be completely communicated to the Controller 4 via a Master Packet 70, 80, one or more Slave Packets 70, 80 are formed and sent via the Internet 8 to the Controller 4. The Master and Slave Packets 70, 80 may contain elements of a file, scheduling information directing the timing of the performance of the requested action, the Controller ID, and information contained in any file sent by the user to the Server.

In the preferred embodiment the Blue Iguana Payloads 6D of the Data Packet 70, 80 are encrypted using the appropriate public key, and the Blue Iguana Headers 6C are not encrypted.

The Master and Slave Packets 70, 80 are transmitted to the Controller 4 by the Server 10 and over the Internet 8 in Step 5F. In the preferred embodiment the Master and Slave Data Packets 70, 80 are sent serially to the Controller 4. The Controller 4 communicates an acknowledgement of receipt of each Data Packet 70, 80, and the Server 10 waits to receive an acknowledgment from the Controller 4 before sending a next Data Packet 70, 80.

The Controller 4 executes the command transmitted by the server after the completion of Step 5F. In Step 5G the Controller reports back to the Server 10 regarding the status of the execution of the transmitted command.

Referring now to the Figures, and particularly to FIG. 7, the Server 10 of the preferred embodiment employs secure transaction techniques when communicating with the Controllers 4 through the Internet 8 and through other suitable computer communications networks. The standard Internet communications protocol of the preferred embodiment is TCP/IP. TCP/IP has two parts, namely Internet Protocol, or IP, which represents the basic functionality necessary for getting a packet from one computer the other, and specifying addressing, routing, fragmentation, etc., and secondly a Transmit Control Protocol, or TCP, which represents the more advanced functionality required for communication coordination, such as out-of-order delivery, three-phase handshaking, sessions, acknowledgements and etc.

The Data Packet 70 of FIG. 7 is formatted to include a Top-level Header 7A, such as an Ethernet header, and a Top-level Payload 7B The Top-level Payload incorporates and encapsulates an IP Header 7C and an IP Payload 7D. The IP Payload further incorporates and encapsulates an Inner Protocol Header 7E and an Inner Protocol Payload 7F. The Inner Protocol Header 7E may comprise a TCP header, a UDP header, or another suitable alternate communications protocol header known in the art. The Inner Protocol Payload 7F incorporates and encapsulates the Blue Iguana Header 6C and the Blue Iguana Payload 6D.

In the preferred embodiment the Server 10 can communicate directly with the Controller 4 using the Internet 4, without the use of an embedded operating system or a microprocessor. The Prior Art requires some direct connection and some form of device driver, but the preferred embodiment operates in a manner novel and distinct from the Prior Art. The Controller 4 implements a network stack or interface to a separate dedicated network stack chip. This would directly connect to an Ethernet/ATM/SONET/Token Ring or other Internet capable network. The Controller 4 of the preferred embodiment may have an advanced design whereby several layers of networking are implemented.

FIG. 7 illustrates how the certain communication protocols of the preferred embodiment relate to each other. Several protocols encapsulate the text of another protocol in a Message 6B, 70, & 80 format.

Referring now generally to the Figures and particularly to FIG. 8, an Internet Protocol Security, or IPSec, is integrated into the format of a Message 80. IPSec is a communications protocol that expands the packet format to include security components. IPSec provides for both authentication and encryption, and supports any algorithm for either action by abstracting it as a Security Association, or SA. IPSec defines a method for establishing and using an algorithm by creating an SA for it. Existing IPSec software toolkits may be used by the Server 10 to implement IPSec, and in the preferred embodiment IPSec is implemented in the design of Controller 4.

The ESP components 8A, 8B, 8C & 8D of the Data Packet 80 of FIG. 8are the IPSec additions to the Data Packet 80 of FIG. 8.

Referring now generally to the Figures, and particularly to FIG. 6, the preferred embodiment uses an additional communications protocol, or Blue Iguana Protocol 6B, for formatting Application Data 6A within the Data Packet 70, 80. Like other protocols the Blue Iguana Protocol 6B, or BIP, separates Application Data 6A into a Blue Iguana Header 6C and a Blue Iguana Payload 6D as shown in FIG. 6.

The BIP Header 6C contains information related to coordination, acknowledgements, structural variants, and other protocol information. Based on the reading of the BIP Header 6C by the Sniffer 34a the Controller 4 can determine how to interpret and act on the BIP Payload 6D.

The BIP Header 6C comprises several data fields. The VER field, which is similar to an IP VER field, indicates the version of the BIP Header 6C and Payload 6D. The initial value of the VER Field is typically 0, and this should value until it is released to production. After production any new releases may be given new numbers. The VER Field is 4 bits and thereby allows for 16 versions before wraparound occurs.

The RESERVED field is space left open for changes.

The SEQUENCE NUMBER field is used to synchronize groups of Data Packets. The Server uses 10 the value of the SEQUENCE NUMBER to group together packets that will be sent to an individual Blue Iguana. A group is considered to be a series of packets which can be acknowledged in a single Message.

The ACK NUMBER is only used in response packets. A Blue Iguana Protocol 6A response will fill in this field with the packet that is being acknowledged. This system allows a packet to contain information as well as acknowledge a packet.

The COMMAND TYPE is for use when commands are sent as coarse-grained messages, which assumes the Controller 4 turns it into more detailed actions, including individual memory changes.

The PAYLOAD LENGTH indicates the length of the BIP Payload 6D.

The BIP command scheme of the preferred embodiment incorporates the execution of memory-mapped I/O over the Internet 8 or a suitable computer network from a remote location. Sufficient knowledge of how to execute a command is available to the Server 10. The Server 20 sends write commands to specific memory locations, with specific data to be put there. Certain register locations will trigger actions by the Controller 4.

The Controller 4 reads through the payload and writes each data chunk to the associated address. The Payload is formatted as a series of <address, data>pairs.

The functions described herein of message and message sender validation, authorization, credentialization and authentication may be performed by applying suitable message and message sender validation, authorization, credentialization and authentication techniques, systems and methodologies known in the art and in a numerous variety of alternate preferred embodiments of the method of the present invention.

The use of memory mapped I/O in the communications of commands and data between the Controller 4 and the Server 10, between the Controller 4 and the Target 6, or between the Server 10 and the Target 6, may be performed by applying suitable memory mapped I/O methods and techniques known in the art and in a numerous variety of alternate preferred embodiments of the method of the present invention.

Those skilled in the art will appreciate that various adaptations and modifications of the just-described preferred embodiments can be configured without departing from the scope and spirit of the invention. Digital signature authentication methods, and public key cryptography applications, and other suitable authentication techniques and methods can be applied in numerous specific modalities by one skilled in the art and in light of the description of the present invention described herein. Therefore, it is to be understood that the invention may be practiced other than as specifically described herein.

We claim:

1. A method for delivering data to a target, the method comprising:
building a data packet, the data packet comprising a header and a payload;
writing data into the payload;
writing processing instructions into the header, and the processing instructions specifying that the data is to be stored in a memory prior to delivery to the target;
providing a computer network, and transmitting the data packet via the computer network;
delivering the data packet via the computer network to a sniffer of a controller, the controller comprising the sniffer and the memory, via the computer network, and coupling the controller to the target;
the sniffer reading the processing instructions, and the sniffer informing the controller to store the data in the memory;
delivering the data via the controller to the memory according to the processing instructions; and
delivering the data from the memory and to the target via the controller.

2. The method of claim 1, wherein the payload comprises target upgrade information.

3. The method of claim 2, wherein the delivery of the upgrade information to the target and the processing instructions specify a time for the delivery of the data to the target.

4. The method of claim 1, wherein said memory is non-volatile memory.

5. The method of claim 4, wherein a first plurality of payloads are stored in a first sector of the memory, and a second plurality of payloads are stored in a second sector of the memory.

6. A method for delivering reprogramming information to a controller, the method comprising:
providing a controller and a target, and coupling the reprogrammable controller and the target,
building a data packet, the data packet comprising a header and a payload;
writing reprogramming data into the payload;
writing processing instructions into the header, and the processing instructions specifying that the data is to be stored in a memory prior to reprogramming the controller;
providing a computer network, and transmitting the data packet via the computer network;
delivering the data packet via the computer network to a sniffer of a controller, the controller comprising the sniffer and the memory, via the computer network;
the sniffer reading the processing instructions, and the sniffer informing the controller to store the data in the memory;
delivering the data via the controller to the memory according to the processing instructions; and
reprogramming the controller by delivering the information stored in the memory to the controller.

7. The method of claim 6, wherein a first sector of the memory holds a first plurality of payloads, and the first plurality of payloads comprises a first set of reprogramming instructions for the controller, and the controller is reprogrammed by reprogramming the controller with the first set.

8. The method of claim 7, wherein a second sector of the memory holds a second plurality of payloads, and the second plurality of payloads comprises a second set of reprogramming instructions for the controller, and the controller is reprogrammed by reprogramming the controller with the second set.

9. The method of claim 1, wherein the information contained in the data packet comprises information of one of the types of software or firmware upgrades for the target, remote control monitoring instructions or information, commands, diagnostic software, digital signatures, license identifications, operational histories, status report, status queries, information or measurements relevant to royalty tabulations, firmware enhancements, digital watermarks, monetary or pseudo-monetary tokens or account information, operational limitations or permissions, terms or conditions of licenses, and other suitable types of information, data or instructions known in the art.

10. The method of claim 1, wherein the processing instructions direct the controller to transfer the data to the target and bypass the memory.

11. The method of claim 1, further comprising the target peforming a self-test after receiving the data from the controller.

12. The method of claim 11, further comprising a selective delivery of data from the memory after the target fails a self test.

13. The method of claim 11, further comprising a notification by the target to the controller of a failure of a self test by the target.

14. The method of claim 1, further comprising;
providing a server and coupling the server to the computer network; and
requiring the target to communicate with server periodically in order for the controller to continue functioning.

15. The method of claim 1, further comprising the provision and use of a hardware accelerator with the controller, whereby the controller speed of operation is increased.

16. The method of claim 1, further comprising the generation of communication transaction identifier records, wherein the message transmitted by the controller over the computer network includes information identifying the message addressee and the message originator.

17. The method of claim 5, further comprising the provision and use of more than two sectors of memory.

18. The method of claim of claim 8, further comprising more than two sets of programming instructions, and storing each set in a separate sector of the memory.

19. The method of claim 1, further comprising the use of a public and private encryption key pair, wherein the data is encrypted with the private key prior to transmission via the computer network and a message controller uses the public key to decrypt the data.

20. The method of claim 1, further comprising the generation and use by the controller of a controller public and private encryption key pair, wherein the controller transmits the controller public key to an addressee, and the controller encrypts a portion of a message with the controller private key, and the controller transmits the message after encryption to the addressee.

21. The method of claim 1, further comprising the authentication of the sender of a message received via the computer network by the controller means of the public key.

22. The method of claim 1, further comprising a reset of the target prior to the delivery of the data to the target.

23. The method of claim 22, further comprising a request for reset signal from the controller to the target and a time out or an acknowledgement signal from the target.

24. The method of claim 22, further comprising a real time clock for use by the controller and target in scheduling the delivery of the data to the target.

25. The method of claim 1, the controller further comprising a real time clock.

26. The method of claim 1, further comprising the generation and inclusion of native language commands in the data packet and for use in reprogramming the target.

27. The method of claim 1, further comprising the generation and inclusion of memory mapped data in the data packet and using the memory map data to reprogram the target.

28. A system for reprogramming a target via the Internet, the system comprising:
A server, the server coupled with the Internet;
A controller, the controller comprising a memory;
A target, the target coupled with the controller,
The server for transmitting a plurality of data packets to the controller via the Internet; and
The controller for receiving the plurality of data packets and storing at least a fraction of the data packet in the memory, and the controller reprogramming the target with the fractions of data packets stored in the memory.

29. An apparatus for reprogramming a target, the apparatus comprising:
A sniffer, the sniffer for reading a header of a data packet, and the sniffer storing a payload of the data packet in a memory when directed to by information stored in the header;
The memory for storing the payloads, the memory coupled with the sniffer; and
An upgrade processor for delivering the payloads to the target, the upgrade processor coupled to the memory and the target.

30. The method of claim 1, further comprising the controller retrievably storing the data in the memory in scrambled memory addresses.

31. The method of claim 1, further comprising the controller encrypting the data prior to retrievably storing the data in the memory.

32. The method of claim 1, further comprising the controller encrypting the data prior to retrievably storing the data in the memory in scrambled memory addresses. The method of claim 30, further comprising the provision and use of hardware circuitry to enable the retrievable storage of the data in scrambled memory addresses.

33. The method of claim 31, further comprising the provision and use of reconfigurable hardware circuitry to enable the retrievable storage of the data in scrambled memory addresses.

34. The method of claim 30, further comprising the provision and use of reprogrammable software instructions to enable the retrievable storage of the data in scrambled memory addresses.

35. The method of claim 31, further comprising the provision and use of hardware circuitry to enable the encryption of the data prior to retrievable storage of the data in the memory.

36. The method of claim 35, further comprising the provision and use of reconfigurable hardware circuitry to enable the encryption of the data prior to retrievable storage of the data in the memory.

37. The method of claim 31, further comprising the provision and use of reprogrammable software instructions to enable the retrievable storage of the data in the memory.
